(19) United States
(12) Patent Application Publication
(10) Pub. No.: US 2013/0062813 A1
(43) Pub. Date: Mar. 14, 2013

(54) PLASTIC INJECTION PRODUCT MANUFACTURING SYSTEM AND METHOD

(71) Applicants: FANG JIANG, Shenzhen City (CN); FA-YE LI, Shenzhen City (CN); SHUN-BAI WU, Shenzhen City (CN); DAI-PING ZHOU, Shenzhen City (CN); HAO-QUAN WU, Shenzhen City (CN); PENG TAN, Shenzhen City (CN); CUI CHEN, Shenzhen City (CN)

(72) Inventors: FANG JIANG, Shenzhen City (CN); FA-YE LI, Shenzhen City (CN); SHUN-BAI WU, Shenzhen City (CN); DAI-PING ZHOU, Shenzhen City (CN); HAO-QUAN WU, Shenzhen City (CN); PENG TAN, Shenzhen City (CN); CUI CHEN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/525,597

(22) Filed: Jun. 18, 2012

(30) Foreign Application Priority Data
Sep. 13, 2011 (CN) 201110268933.5

(51) Int. Cl. B29C 45/76; B29C 45/00; B29C 45/03

(52) U.S. Cl. 264/328.1; 425/563; 425/162

(57) ABSTRACT

A plastic injection product manufacturing system includes a forming machine, a PLC module, an oil output module, an oil vat, and a cutter. The forming machine includes a mold cavity for forming a plastic injection product. The mold cavity defines a gate for receiving molten plastic material. The PLC module is connected to the forming machine. The oil output module is connected to the PLC module. The oil vat is connected to the oil output module. The oil vat includes a vat body and a piston slidably mounted in the vat body. The cutter is connected to the piston. The PLC module controls the oil output module to output hydraulic pressure oil, after receiving a control signal from the forming machine, to the vat body of the oil vat to drive the piston to move. The cutter is driven to move to cut off plastic material out of the gate.

### BACKGROUND

1. Technical Field

The present disclosure relates to manufacture systems and methods, and more particularly to a plastic injection product manufacture system and method.

2. Description of Related Art

Plastic molds include a plurality of mold cavities for molding the plastic injection products. Each mold cavity has a gate which is connected to a channel to receive molten plastic material. A plastic injection product is formed and connected to a plastic part in the channel when the plastic material is solidified. The plastic part is cut off from the plastic injection product manually, which is time consuming.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a plastic injection product manufacture system.

FIG. 2 is a block diagram of a forming machine of FIG. 1.

FIG. 3 is an assembled view of a PCL module and an oil output module of FIG. 1.

FIG. 4 is an isometric, exploded view of an oil vat, a cutter, and two elastic elements of FIG. 1.

FIG. 5 is a flowchart of an embodiment of a plastic injection product manufacture method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

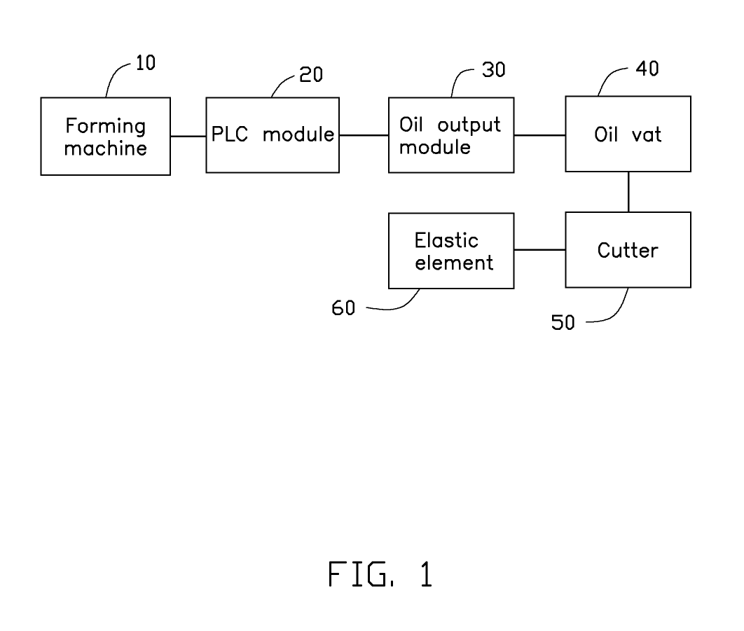

Referring to FIG. 1, a plastic injection product manufacture system includes a forming machine 10, a programmable logic controller (PLC) module 20 connected to the forming machine 10, an oil output module 30 connected to the PLC module 20, an oil vat 40 connected to the oil output module 30, a cutter 50 connected to the oil vat 40, and two elastic elements 60 connected to the cutter 50. In one embodiment, the elastic elements 60 are springs.

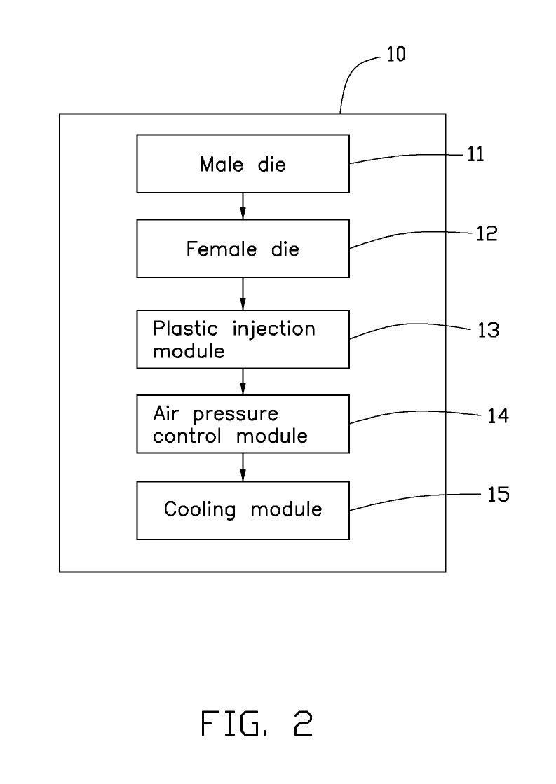

Referring to FIG. 2, the forming machine 10 includes a male die 11, a female die 12, a plastic injection module 13, an air pressure control module 14, and a cooling module 15. When a plastic injection product is manufactured, a mold cavity is defined between the male die 11 and the female die 12 after they are combined together. The plastic injection module 13 injects molten plastic material to the mold cavity via a gate of the mold cavity. The air pressure control module 14 applies air pressure to the molten plastic material of the mold cavity to prevent the molten plastic material from producing air bubble. The cooling module 15 then solidifies the molten plastic material to form a plastic injection product.

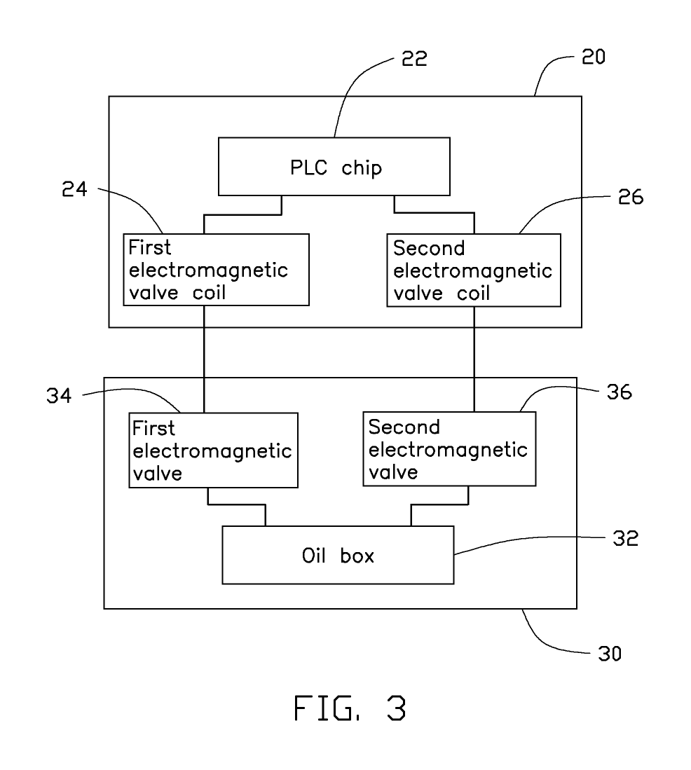

Referring to FIG. 3, the PLC module 20 includes a PLC chip 22, a first electromagnetic valve coil 24, and a second electromagnetic valve coil 26 both connected to the PLC chip 22. The PLC chip 22 is capable of outputting a high level or low level voltage to the first electromagnetic valve coil 24 and the second electromagnetic valve coil 26.

The oil output module 30 includes an oil box 32, a first electromagnetic valve 34, and a second electromagnetic valve 36 both connected to the oil box 32. The first electromagnetic valve 34 and the second electromagnetic valve 36 are connected to the first electromagnetic valve coil 24 and the second electromagnetic valve coil 26. The first electromagnetic valve 34 is turned on or turned off when the first electromagnetic valve coil 24 receives a high level or low level voltage. The second electromagnetic valve 36 is turned on or turned off when the second electromagnetic valve coil 26 receives a high level or low level voltage. The oil box 32 stores hydraulic pressure oil. The oil box 32 outputs hydraulic pressure oil to the oil vat 40 when the first electromagnetic valve 34 is turned on and the second electromagnetic valve 36 is turned off. The oil vat 40 outputs hydraulic pressure oil to the oil box 32 when the first electromagnetic valve 34 is turned off and the second electromagnetic valve 36 is turned on.

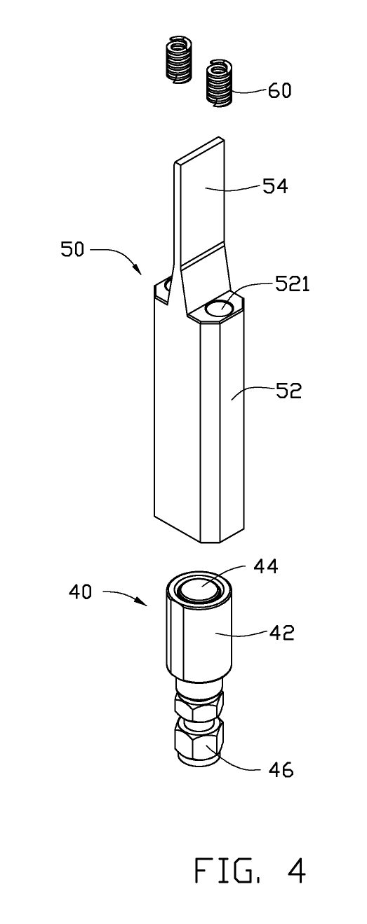

Referring to FIG. 4, the oil vat 40 includes a vat body 42, a piston 44 slidablly mounted in the vat body 42, and a connecting head 46 formed on the bottom portion of the vat body 42. The connecting head 46 is connected to the oil output module 30 via a pipe for receiving oil from the oil output module 30. The cutter 50 includes a cutter body 52 and an incising portion 54 extending from the cutter body 52. The cutter body 52 defines two mounting holes 521. Each mounting holes 521 is used for receiving one elastic element 60.

In assembly, the cutter body 52 of the cutter 50 is secured to the piston 44 and the elastic elements 60 are mounted in the mounting holes 521. The oil vat 40 and the cutter 50 are mounted in the male die 11. The incising portion 54 corresponds to the gate of the mold cavity. The elastic elements 60 resist resiliently between the male die 11 and the cutter 50 for pushing the cutter 50 and the piston 44 back to the original position.

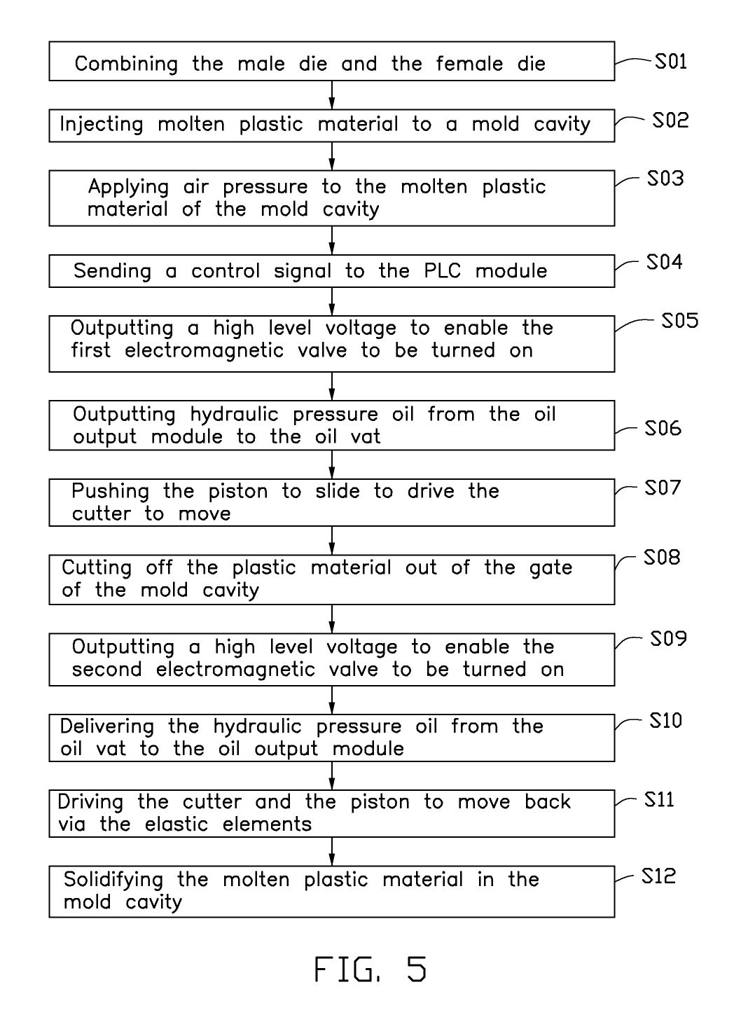

Referring to FIG. 5, a plastic injection product manufacturing method of one embodiment includes the following steps.

SOL the male die 11 and the female die 12 of the forming machine 10 are combined together.

S02, the plastic injection module 13 injects molten plastic material to the mold cavity defined by the male die 11 and the female die 12 via the gate of the mold cavity.

S03, the air pressure control module 14 applies air pressure to the molt plastic material in the mold cavity.

SO4, the forming machine 10 sends a control signal to the PLC module.

SO5, the PLC chip 22 of the PLC module 20 outputs a high level voltage to the first electromagnetic valve coil 24 and outputs a low level voltage to the second electromagnetic valve coil 26 to enable the first electromagnetic valve 34 to be turned on and enable the second electromagnetic valve 36 to be turned off.

S06, the oil output module 30 outputs hydraulic pressure oil to the vat body 42 of the oil vat 40.

S07, the hydraulic pressure oil in the vat body 42 of the oil vat 40 pushes the piston 44 to slide upwards to drive the cutter 50 to move.

S08, the incising portion 54 of the cutter 50 is driven to move to cut off the plastic material out of the gate of the mold cavity. At this time, the elastic elements 60 are deformed.

S09, the PLC chip 22 of the PLC module 20 outputs a low level voltage to the first electromagnetic valve coil 24 and outputs a high level voltage to the second electromagnetic valve coil 26 to enable the first electromagnetic valve 34 to be turned off and enable the second electromagnetic valve 36 to be turned on.

S10, the oil vat 40 delivers hydraulic pressure oil to the oil output module 30.

S11, the elastic elements 60 release to drive the cutter 50 and the piston 44 to move back to the original position.

S12, the molten plastic material in the mold cavity is solidified by the cooling module 15 to form a plastic injection product.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A plastic injection product manufacturing system, comprising:
a forming machine, the forming machine comprising a mold cavity for forming a plastic injection product, the mold cavity defines a gate for receiving molten plastic material;
a PLC module, the PLC module is connected to the forming machine;
an oil output module, the oil output module is connected to the PLC module;
an oil vat, the oil vat is connected to the oil output module, and the oil vat comprises a vat body and a piston slidably mounted in the vat body; and
a cutter, the cutter is connected to the piston;
wherein the PLC module is configured to control the oil output module to output hydraulic pressure oil, after receiving a control signal from the forming machine indicating the molten plastic material being in the mold cavity, to drive the cutter to move to cut off plastic material out of the gate by pushing the piston.

2. The plastic injection product manufacturing system of claim 1, wherein the oil output module comprises an oil box storing hydraulic pressure oil, a first electromagnetic valve, a second electromagnetic valve connected to the oil box; the oil box outputs hydraulic pressure oil to the vat body when the first electromagnetic valve is turned on and the second electromagnetic valve is turned off; and the vat body outputs hydraulic pressure oil to the oil box when the first electromagnetic valve is turned off and the second electromagnetic valve is turned on.

3. The plastic injection product manufacturing system of claim 2, wherein the PLC module comprises a PLC chip, a first electromagnetic valve coil, and a second electromagnetic valve coil both connected to the PLC chip; the first electromagnetic valve coil is configured to receive a high level voltage to make the first electromagnetic valve to be turned on; and the second electromagnetic valve is configured to receive the high level voltage to make the second electromagnetic valve to be turned on.

4. The plastic injection product manufacturing system of claim 1, further comprising an elastic element, wherein the elastic element is located between the cutter and the forming machine, and the elastic element is configured to release to pull the cutter back to an original position after the cutter cuts off the plastic material out of the gate.

5. The plastic injection product manufacturing system of claim 3, wherein the forming machine comprises a male die, a female die, a plastic injection module, an air pressure control module, and a cooling module; the mold cavity is defined between the male die and the female die; the plastic injection module is configured to inject the molten plastic material to the mold cavity; the air pressure control module is configured to output air pressure to the molten plastic material in the mold cavity; and the cooling module is configured to cool the molten plastic material in the mold cavity after the air pressure control module outputs air pressure to the molten plastic material in the mold cavity.

6. A plastic injection product manufacturing method, comprising:
injecting molten plastic material to a mold cavity via a gate of the mold cavity;
outputting air pressure to the mold cavity;
sending hydraulic pressure oil from an oil output module to an oil vat;
pushing a cutter, connected to a piston of the oil vat, via the hydraulic pressure oil, to cut off molten plastic material out of the gate; and solidifying molten plastic material in the mold cavity.

7. The plastic injection product manufacturing method of claim 6, further comprising delivering the hydraulic pressure oil from the oil vat to the oil output module after the cutter cuts off the molten plastic material out of the gate.

8. The plastic injection product manufacturing method of claim 7, wherein the delivering the hydraulic pressure oil comprises controlling an electromagnetic valve to be turned on so as to enable the hydraulic pressure oil to be delivered from the from the oil vat to the oil output module.

9. The plastic injection product manufacturing method of claim 6, further comprising pulling the cutter to an original position after the cutter cuts off the molten plastic material out of the gate.

10. The plastic injection product manufacturing method of claim 6, wherein the sending the hydraulic pressure oil comprises controlling an electromagnetic valve to be turned on so as to enable the hydraulic pressure oil to be outputted from the from the oil output module to the oil vat.
